(19) United States
(12) Patent Application Publication
(10) Pub. No.: US 2004/0128139 A1
(43) Pub. Date: Jul. 1, 2004

(54) Method for voice activated network access

(76) Inventors: Cohen Ilan, Beit Shemesh (IL); Peter Merguerian, Jerusalem (IL); Robert Morris, Tel Mond (IL)

Correspondence Address: Cohen Ilan, PO Box 2354, Beit Shemesh, 99000, IL

(21) Appl. No.: 10/220,976

(22) PCT Filed: Apr. 5, 2001
(86) PCT No.: PCT/IL01/00319

(51) Int. Cl. G10L 19/00

(52) U.S. Cl. 704/275

(57) ABSTRACT

A system and method for enabling voice-activated access to networks, including voice-based navigation and data communication. This incorporates an integrated method utilizing both hardware and software located inside the network “cloud”, which enables easy, intuitive access service connectivity to independent service providers and to other network users and resources, in both single and multiple networks. Further embodiments of the present invention include implementations with other different types of networks (ISDN or SS7 option). The present invention, or Access Service Connectivity Platform, may be integrated into but not limited to commonly distributed circuit switched networks, Intelligent Network infrastructures, VoIP networks, wireless networks, and HFC (Hybrid Fiber Coax) networks.

### FIELD AND BACKGROUND OF THE INVENTION

The present invention relates to a system and method for enabling voice activated network access, and voice activated access of independent network services, users and resources on single or multiple networks.

In both the wireline and wireless telecommunications worlds, a variety of services exist. These include but not limited to:

Telephony based services, such as Person-to-Person calls, Call Centers, Banks, Airport information, Weather Information, Voice mail, Video conferencing etc.

Cellular based services, such as independent internal information services, M-commerce, etc.

Internet based services, such as WAP, Voice browsing, Call routing, Multimedia, E-commerce, email, etc.

These services combine Computer Telephony Integrated (CTI) technologies such as Interactive Voice Response (IVR), Text To Speech (TTS) and Automatic Speech Recognition (ASR), which are already implemented and allow services, significantly saving time and money.

Wireline, wireless or Internet services are independent services. Wireline or wireless services are dialed into, and Internet services are linked into via a network connection. Some services allow a selection between a few types of databases or services all within a single platform, small or large, on a local or global scale.

The user, wireless or wireline, of the vast variety of services has to recall and/or dial a large number of telephone numbers or WWW addresses (bookmarks) for each requested service. This may be a time-consuming and frustrating user experience, limiting the user to usage of pre-configured book marked services.

With regards to wireline access infrastructures to networks, access is typically enabled using copper wire connections, known also as pairs of tip and ring. The most commonly used network is the PSTN (switched) network where access is achieved via POTS lines. In parallel to the PSTN network there are a few types of DATA networks such as ATM, Frame Relay or IP. The DATA networks are usually accessed via ISDN, xDSL or the PSTN network.

With regards to wireless access infrastructures to networks, access is typically enabled using radio frequencies to communicate between the user and the network. The connection may be a WLL (Wireless Local Loop) type that emulates a standard PSTN or DATA network connection. A different type of wireless access is initiated via the cellular type of network interfaces typically known as TDMA, AMPS, CDMA or GSM.

FIG. 1(a,b) demonstrates a typical wireline or wireless network. The user 10 accesses the multitude of services via the local access switch 15, by dialing a specific number of a service provider 11 X, Y or Z. The user 10 also accesses other users resident on the network via a conventional telephone call, by dialing their uniquely allocated telephone numbers. The user 10 has to remember or to record (store) required numbers, and to be able to retrieve the numbers every time a service is required or a person needs to be contacted.

FIG. 1b demonstrates a typical wireless, or more particularly, Cellular network, which may enable more advanced, feature reach, access to network services, which are restricted to a service provider's own platform environment 18. This is referenced in the figure by a Z type of service 18. These services, such as WAP services, are accessible only to the users of the cellular network and are not accessible to users from other networks.

U.S. Pat. No. 5,923,745 describes a system for routing calls to call centers (referred to as service providers). The system includes a plurality of call centers coupled to a public switched telephone network which supports a caller identification feature and a transfer feature. This invention focuses only on call center routing functions, and does not include voice web/internet connectivity functions. This invention makes no use of IN (Intelligent Networks) efficiency, and nor does it offer the ability to transfer the voice call through the voice channel back into the switch, in order to save call center resources. This system requires a user to call into it, and therefore dialing into the system is always required.

U.S. Pat. No. 5,418,844 describes a system for Automatic access to information service providers. The system utilizes a short dedicated code, such as an N11 telephone number, which is used to access an information source selected from a large number of voice, data, facsimile and/or video services offered by information service providers. The invention also provides customized routing and call processing procedures for different customers and for accessing different providers' services This system, however, is based on a quick dial only, but does not allow connections at the time when the user is in “off hook” mode without any key pressing. Moreover, this invention does not include voice recognition as the method for selecting a service. Furthermore, this invention requires users to know a selection of numbers and codes for accessing information, again dialing numbers and remembering access codes.

U.S. Pat. No. 5,675,707, by AT&T, describes a system for automated call routing, called “how may I help you”. This invention describes an automated call routing system and method, which operates on a call-routing objective of a calling party, expressed in natural speech of the calling party. This AT&T patent is a general patent that relates to the voice conversation dialogue, but does not relate to a network voice activated routing/connectivity function. The AT&T patent methodology is related to call center or portal information gathering with the help of voice. Connectivity functions attached to the central core of the network are not covered by AT&T patent.

None of the above described patents, and no known prior art technologies, provide for a system that enables voice-driven access and connectivity functions to networks, wherein the systems are located/attached to the switching center of the network. None of the known technologies provide for such a system that would enable hands free activated access to independent network services, users and resources on single or multiple networks.

There is thus a widely recognized need for, and it would be highly advantageous to have, a system that can enable voice-driven access of networks, in order to provide users with the tools required to use voice to navigate and communicate across single or multiple networks. Furthermore, there is a widely recognized need for a voice navigation system that is based in the heart of the network (such as a PSTN switch), so that it enables a transparent link that seamlessly blends/converges the legacy telecommunications network with the global information and data pool.

The present invention, in contrast to the above describes technologies, claims a simple connectivity selection and does not pretend to intelligently understand what the user is looking for. The present invention is based on a set of known or menu selected commands, and is not a dialogue-centered patent. The present invention is a system that may incorporate a system such as the AT&T invention (U.S. Pat. No. 5,675,707) as a purchased component.

The present invention provides a solution for the above-mentioned challenges, by enabling a system that provides:

1. No more “dial tone”, such that a radical change is executed for landline and wireless telecommunications, by replacing the dial tone with name/voice-based addressing. As dot-com addresses like Amazon.com, (rather than IP addresses like 181.203.174.6), enabled the WWW to become an information repository and a tool for commerce, so too the present invention eliminates the need to use numbers to connect to destinations, and enables telephone users to easily access voice-relayed data and information (the “voice web”) and voice-based commerce (“v-commerce”) services.

2. Natural Connectivity, such that users do not need to know the telephone number of a destination, when using the telephone, and where a user can connect to a friend, family, business associate or stockbroker by name and address. This more natural form of addressing enables carriers to offer new services like placement for searching/directory listings, and virtual PBXs that allow direct connectivity to an individual's extension within corporate phone networks, enhanced voice mail offerings and other services. According to this embodiment, there will is no more dial tone, and no need for numerical keypads; instead voice-activated “Internet dialing” accesses voice-enabled “web sites” and uses new voice-based applications and services for information retrieval and commerce.

3. Enabled Services Including Spoken Navigation & Browsing:

The present invention enables the following services:

i. Voice navigation into call centers, voice portals, virtual PBX's and voice-activated services by picking up the telephone and saying the name of the entity. Connection is established via the system of the present invention (referred to in this document as, “Access Service Connectivity Platform”) without the caller having to know the telephone number or web address of the organization's voice service.

ii. Voice activated voice-web browsing—delivering voice connectivity to information and services where the caller wishes to receive information or obtain a service but does not know the service provider by name. This is equivalent to a voice-generated Internet browser. The caller navigates through voice activated databases until the desired content or service is located, after which the present invention makes a connection to the call center, service, or voice website.

4. The Need for Central Connectivity: The present invention provides for a centrally located voice connectivity facility that offers the infrastructure support needed for emerging voice-activated applications and services that are taking advantage of the latest innovations in voice recognition technology. Speech recognition technologies—particularly natural speech recognition—have sufficiently matured and stabilized to permit their cost-effective use of such a system as a central tool for distributing non-visual data. Almost every organization or company, whether commercial, governmental or non-profit, has its own Internet website as a means for communicating information and providing services to the world at large. The voice-activated Internet is in its early stages of creation and will probably overtake the computer-based Internet in terms of content and usage. This is due to the telephone's near-universal proliferation and its long history as a powerful medium for communication and providing services and information. The next-generation of voice activated systems must be simple to use and more importantly, simple to access. The present invention provides that simple access connectivity enabling connectivity through the use of the human voice and “natural form addressing” to existing companies, call centers and next-generation voice-data services.

Furthermore, the present invention allows voice-activated requests to be made via any communications device, such as a mobile or regular telephone, requiring no product upgrades or modifications. This is also referred to as a thin application, where the user or the end service provider do not have to upgrade their devices or infrastructure. The voice-activated platform of the present invention enables the human voice to be the locator and search device for dialing across traditional telecommunications networks and for browsing through the world's databases and service applications. The device of the present invention is located in the heart of the central offices of the wireline and wireless telephone service providers (that is, CLECs, ILECs, cellular, or CAMV), with a high-speed, direct connection to the “connectivity engines” that are designed to process the “natural form addresses”. By placing the present invention at the center of telecommunications infrastructure, the present invention enables connectivity between the largest populations of consumers and service/information providers located across in the world in a revolutionary fashion.

### BRIEF DESCRIPTION OF THE DRAWINGS

The invention is herein described, by way of example only, with reference to the accompanying drawings, wherein:

FIGS. 1a and b illustrate of a typical access to wireline and wireless networks with independent and dependant services.

FIG. 2 is a generalized illustration of the location of the Access Service Connectivity Platform, with respect to the different users and the globally distributed information. It reflects the integration and convergence of the wireline, wireless and the global information data pool, according to the present invention.

FIG. 3 is an illustration of a single network Access Service Connectivity Platform, according to the present invention.

FIG. 4 is an illustration of a global Access Service Connectivity Platform, according to the present invention.

FIG. 5 is an illustration of the Access service platform basic structure and building blocks.

FIG. 6 is an illustration of the search hierarchy routine according to the present invention.

FIG. 7 is an illustration of the search codes according to the present invention. FIG. 7 also illustrates the basic contents of information on a service in the databases of the present invention.

FIG. 8 is a flow chart illustrating an example of the speech prompt-based operation of the present invention.

FIG. 9a is an illustration of a V5, GR303 implementation diagram.

FIG. 9b is an illustration of V5, GR303 as part of the AN.

FIG. 10 is an illustration of an ISDN (BRI, PRI) interface.

FIG. 11 is an illustration of a detailed network layout, incorporating both present and next generation networks.

FIG. 12 is an illustration of an Intelligent Network Fully redundant network. Layout

FIG. 13a is an illustration of the present invention integrated into a CATV network.

FIG. 13b comprises two figures illustrating additional applications of the present invention in a CATV network.

### SUMMARY OF THE INVENTION

The present invention relates to a system and method for enabling voice-activated access to networks, including voice-based navigation and data communication. This incorporates an integrated method utilizing both hardware and software located inside the network “cloud”, which enables easy, intuitive access service connectivity to independent service providers and to other network users and resources, in both single and multiple networks.

Throughout this patent disclosure the following definitions are used:

access service connectivity method—a method for voice-activated network access.

Access Service Connectivity Platform (local and global)—The software and hardware platform on which the method will be implemented. This term describes the device, of the present invention, located within a box or engine within a communications network.

The Access Service Connectivity Platform provides for an intuitive method for network access by means of voice or key press technologies. The typical access technologies which are or may be used, are IVR (Interactive Voice Response), TTS (Text To Speech), ASR (Automated Speech Recognition), DTMF (Dual Tone Multi Frequency) and/or similar alternative or future access technologies. Network access service connectivity is done at the network level and may be provided by standard Central Office and Access technologies. The Access Service Connectivity Platform enables global connectivity access to any other globally located Access Service Connectivity Platform, for connection purposes.

The method is different from existing voice activated access methods, in that existing voice activated access methods are generally located at the edge of the network, at the user device, or implemented as a call center outside the network, as a service platform. Only the invented method, location within the heart of the network, enables every user of any network to gain Voice activated access to any particular network.

The method revolutionizes existing network access to information services, other users and service providers. Information service providers are limited to providing access to a single platform and within a single platform. The access service connection platform provides a connectivity method, but does not provide any single service. The Access Service Connectivity Platform routes the user to the desired destination using voice activation or key press.

Further embodiments of the present invention are possible implementations of the Access Service Connectivity Platform with DLCs (Digital Loop Carriers) and DSLAMs (DSL Access Multiplexors) or also known as IAD (Integrated Access Devices), with standards that emulate a direct connection between the user and the local exchange switch.

An additional embodiment of the present invention is where the Access Service Connectivity Platform is integrated into an HFC (Hybrid Fiber Coax) network, also known as the CATV infrastructure. The Access Service Connectivity Platform adds voice-activated connectivity to the telephones, which are connected to the set-top boxes at-the subscriber interface. The interface is used in a blocking fashion that interfaces between the voice circuits of the ETC network and the PSTN or PSDN switched networks. The system also allows an alternate connection to the Internet with alternate billing options and alternate enabling applications. Such an interface also allows voice connection and control of other CATV resources using a handset or a microphone and a speaker which are connected to the set-top box.

The present invention additionally provides for the insertion of an additional device between the Access Network (“AN”) and the Local Exchange (“SLE”). This enables the ability to control every telephone call transferred from the local access to the Local Exchange switch. According to this embodiment, the Access Service Connectivity Platform can block the path of every telephone call between the AN and the.

Further embodiments of the present invention include implementations with networks, such as ISDN, using SS7 protocol, such that the Access Service Connectivity Platform is located outside the network cloud, but provides similar services to the implementation where the Access Service Connectivity Platform is located within the core of the network

In a further embodiment of the present invention, the Access Service Connectivity Platform is integrated into the Intelligent Network (IN) infrastructure, such that the Access Service Connectivity Platform will operate in both the circuit switched infrastructure or the packet transmission infrastructure. According to this implementation, the Access Service Connectivity Platform is in a redundant construction to ensure high reliability and close to zero down time.

### DETAILED DESCRIPTION OF THE INVENTION

The present invention relates to a method for voice activated network access.

The following description is presented to enable one of ordinary skill in the art to make and use the invention, as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to allow network access to users, in order to connect to one another and use the growing pool of information worldwide. The present invention incorporates an integrated method utilizing both hardware and software located inside the network “cloud”, which enables easy, intuitive access service connectivity to independent service providers and to other network users and resources.

The principles and operation of a system and a method according to the present invention may be better understood with reference to the drawings and the accompanying description, it being understood that these drawings are given for illustrative purposes only and are not meant to be limiting, wherein:

The following describes a method utilizing hardware and software within the network “cloud”, which enables easy, intuitive and fast access service connectivity to independent service providers and to other network users or resources.

The Access Service Connectivity Platform, or present invention, can better be illustrated by first describing the traditional network connection method.

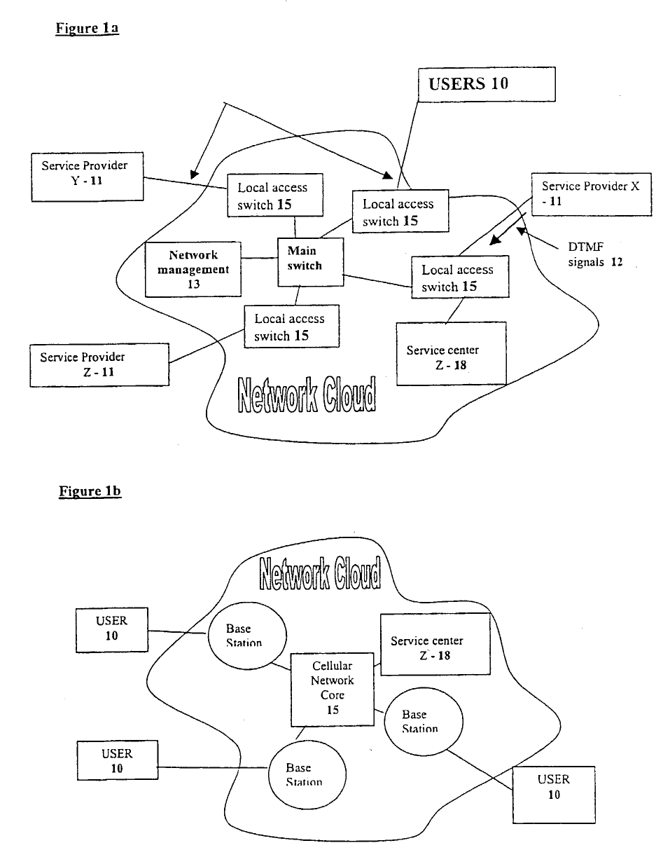

The existing process, as can be seen with reference to FIG. 1a:

1. The network, via the local access switch 15, identifies when a user 10 is connecting to the network. In wireline telephony, this process is typically called off hook position. Typically, a set of DTMF (Dual-Tone Multi Frequency) signals, which are the type of audio signals that are generated when you press the buttons on a touch-tone telephone, identify the destination of the call sent to the network. The network receives a series of signals. Typically DTMF tones 12, where each tone identifies a digit.

2. The signals are transferred to a management layer of the network 13.

3. The calling party 10 is connected with the help of the management layer 13 in the network to the destination party.

4. As long as the call lasts, the management layer 13 checks the time or counts the packets of information for billing purposes. The call can be either a voice conversation or a data connection.

5. When the connection is terminated by one of the users, the management layer 13 of the network is notified and the call is terminated.

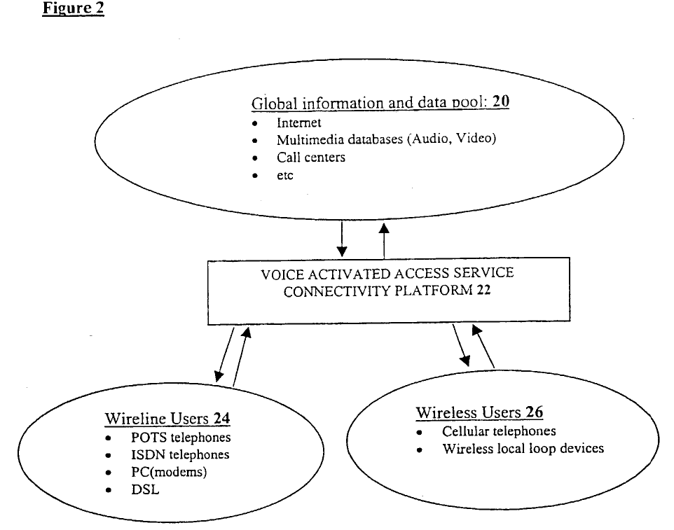

The presently invented method, demonstrating the global voice activated Access Service Connectivity Platform as it is applied in a typical PSTN network module, is illustrated with reference to FIGS. 2-4. As can be seen in FIG. 2, the voice activated Access Service Connectivity Platform 22 is able to connect, receive and forward all communications from and to all wireline 24 and wireless 26 users. FIG. 2 is a generalized illustration of the location of the Access Service Connectivity Platform 22 with respect to the different users and the globally distributed information 20. It presents the integration and convergence of wireline and wireless users to the global data pool. The voice activated Access Service Connectivity Platform 22 may be located at heart or the edges of the network, however, it is preferably located within the Intelligent Network (IN) controlled center, so as to enable seamless and transparent integration into the existing communications network.

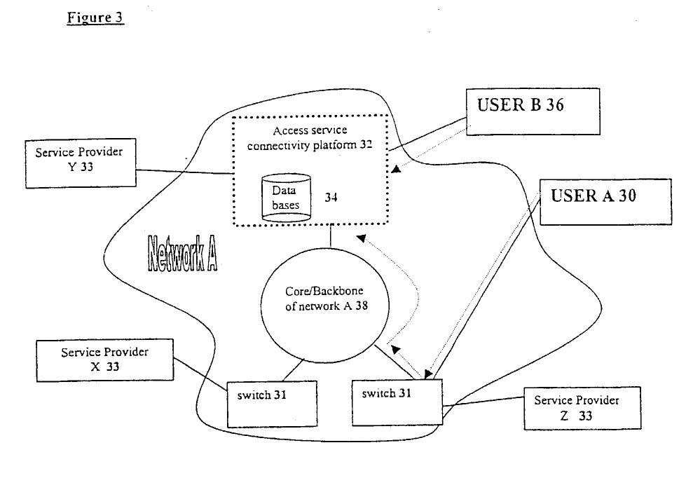

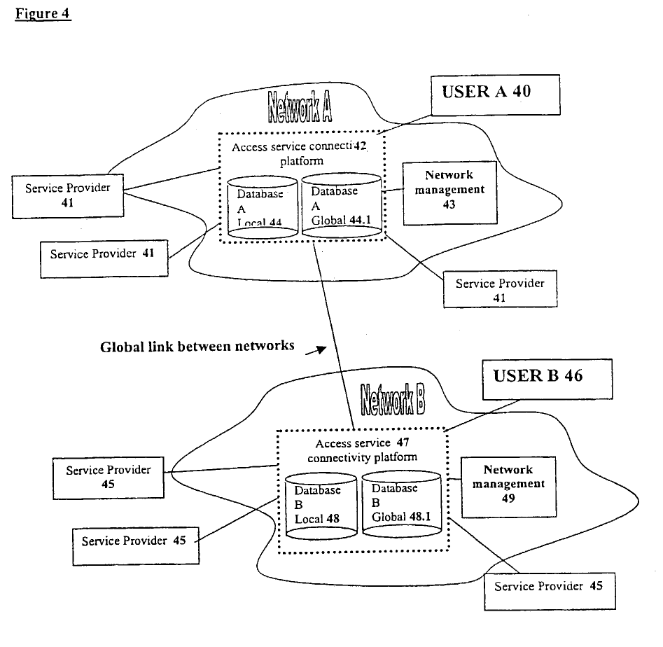

FIGS. 3 and 4 illustrate the Access Service Connectivity Platform and method of the present invention, in both single and global networks. These platforms enable the user to connect to another party according to the following steps:

1. The network (Network A), via a switch 31, identifies when a user 30 is connecting to the network, such that the telephone is considered to be in off hook mode. The connection may be direct or via a quick dial of a number by the user (such as DTMF). A user may similarly access the network via a service provider 33 using any Internet, Packet or other communications network.

2. The switch 31 relays the call to the core/backbone of network A 38, which subsequently transfers the call to the network's Access Service Connectivity Platform 32.

3. The Access Service Connectivity Platform 32 sends a greeting such as “Where can I connect you?”. The greeting can be one or a combination of voice, text or data packets. The greeting can be followed by a dial tone, while barge-in functions for the user 30 are always available, such that the user 30 may execute commands at any time during or following the greeting, or during the dialog.

4. The network's Access Service Connectivity Platform 32 waits for any keywords (voice commands) or key presses that will identify a destination that the user 30 requests, as called for in step 3. System can be also prompted by DTMF.

5. After receiving a response from the user, the Access Service Connectivity Platform 32 searches a local database 34 for the requested call destination.

6. If the Access Service Connectivity Platform 32 cannot clearly identify the call destination, it will start a voice dialogue with the initial user 30 for additional clarifying information. The dialogue can be aided with text and graphics, when applicable. The Access Service Connectivity Platform 32 subsequently connects the initial user 30 to the requested destination, such as user B 36 or service provider Y 33.

7. In the case where the initial user and the call destination, or second user, are in different networks, a global access connectivity database 44.1. 48.1 is used. This database includes references to the locations of other Access Service Connectivity Platforms. As can be seen in FIG. 4 the global access connectivity database is accessed for connection to destinations that are external to the local network. The global destination may be defined as a country or a city, in which case a local access connectivity platform 42 of the country or city is accessed and used for identification of the exact final destination.

8. After the call destination has been identified, it is transferred to the management layer 43 of the network.

9. The calling party 30, 40 is connected to the second party 36, 46, or destination 45 in Network B, with the help of the management layer 49 in the network.

10. As long as the call lasts, the management layer 49 checks the time or counts the packets of information for charging purposes. The connection can be either a voice conversation or a data interchange.

11. When the connection is terminated by one of the users, the management layer 49 of the network is notified and the connection is terminated.

According to the above embodiment, it is evident that user B 36, 46 is directly connected to the Access Service Connectivity Platform 32, 47, and this user 36, 46 can use the local platform 32, 47 directly, without using the network backbone 38. The users 30, 36, and 40, 46 can be connected, via any communications device, including telephone, cellular, PC, to the Access Service Connectivity Platform 32, 47. These connections are via the network, and enable the access of similar services whether access is through a local switch 31 or whether access is routed through the network's backbone 38. User A 30, 40 and User B 36, 46 have full access to all service providers (X, Y or Z) 33, 41 within the local Network A, as well as to all local service providers 45 in external networks.

Information about all service providers, users and network resources, which are local to the network, are stored on the local Access Service Connectivity Platform database 34, 44, 48. Information about global network access options for network A are stored on the globally located global Access Service Connectivity Platform database 44.1, an on network B, in the globally located global Access Service Connectivity Platform database 48.1. When the Access Service Connectivity Platform 42 on network A requires access to network B services, it will have to connect to the Access Service Connectivity Platform 46 of Network B. The USER 40 on network A will use the Network B Access Service Connectivity Platform 46 for searching and connecting to services which are local to Network B.

The method described directly above enables easy, intuitive and fast access to independent service providers and to other network users or resources, using voice commands only. When necessary system can add the usage of DTMF control. The typical technologies used for implementation are IVR, TTS, ASR, DTMF and/or additional or futuristic connectivity technologies. These technologies are prior art and the Access Service Connectivity Platform is using them as building blocks to enable intuitive connection within the network and between networks.

The above method refers to a typical PSTN network it can be implemented in alternative embodiments, with some variations, on a wireless network or via data network (for example, the Internet).

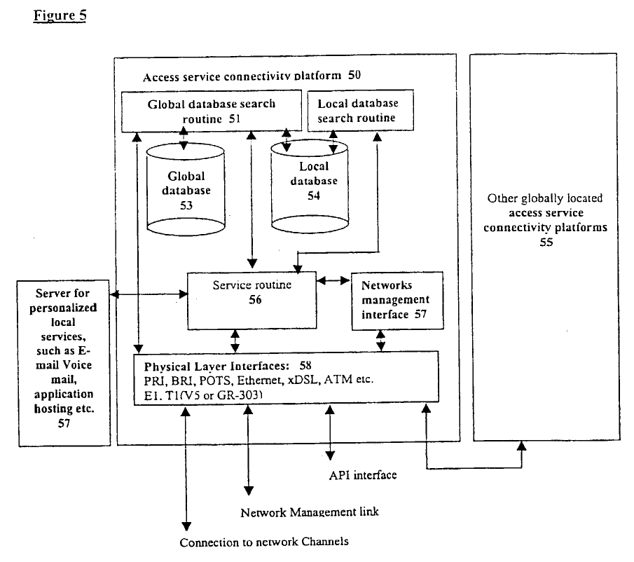

The Access Service Connectivity Platform software structure can be further illustrated by reference to FIG. 5, which describes the basic building blocks of the Access Service Connectivity Platform. The platform has the following properties:

The interface 58 to the network is achieved with a physical layer interface. For example when a telephone call is directed into the platform, it arrives on a channel on a V5 interface or PRI, BRI interface.

The service routine 56 opens a dialogue with the user and searches the local 54 or global databases 53 for the call destination.

The local database 54 includes the telephone numbers or links, which are used by the local user.

The network management interface 57 is required to establish a connection after the destination has been identified. The network management interface 57 may require a separate physical link from the users' voice or data physical link.

The Global database 53 contains the destinations of other access server connectivity platforms to allow global searches.

Application Programming interfaces (APIs) are used for integration of external applications and services, including data entry, system setups, database management, etc., with the present invention.

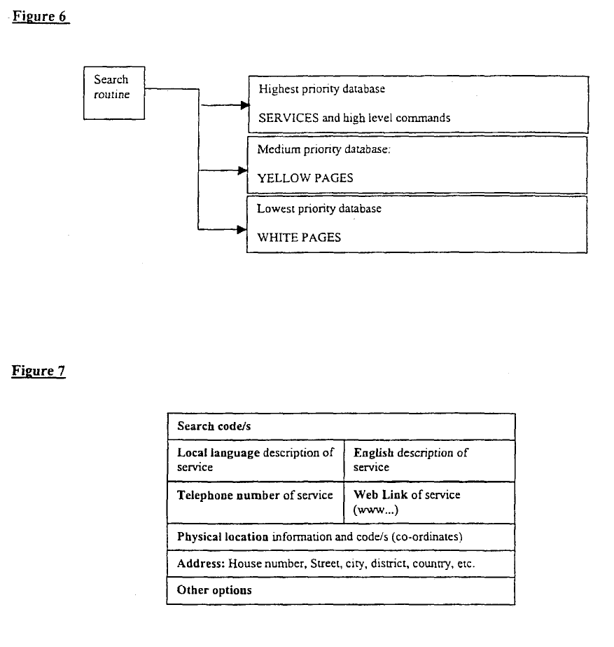

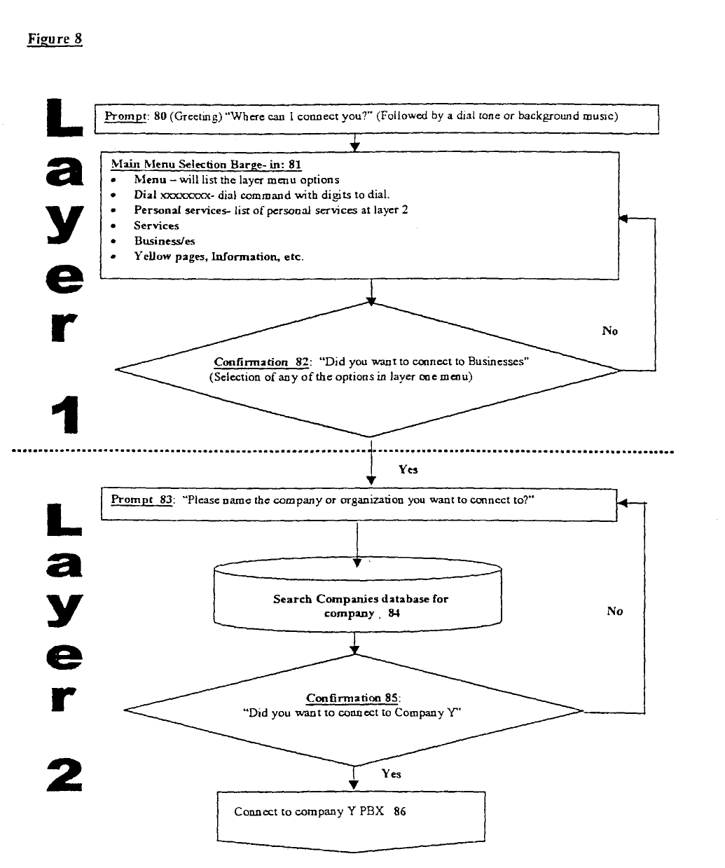

The Local Database 34, 44, 48 and 54, is structured as follows, as can be seen in FIGS. 6 And 7:

FIG. 6 illustrates a typical composition of the database, from highest to lowest priorities for the search routines. The search starts at the highest priority database. Search of the lower priority databases is performed when a user asks for a yellow pages type of service or white pages type of service, which are typically hosted services. The priorities are defined by the service provider.

A highly efficient implementation is to use a central location where different platforms can pull information from a central server containing the databases. This is done because of the need for fast processing when searching data sources such as yellow pages and white pages. Using a remote server alleviates the need to update all access connectivity platforms on a specific network

FIGS. 6 and 7 illustrate the highest priority SERVICES cell structure in a Local database. FIG. 6 describes the structure of a typical search routine. In the figure, it is shown how high, medium and low priorities are defined.

FIG. 7 describes the structure of a cell that contains information about a specific service provider or user destination. The cell is created using a flexible database. This structure of the database enables the service provider to create a scalable and customizable database to determine search preferences, connection destinations data and priorities, visual information of texts and graphics where applicable. For example, the service provider may have a need to offer users access to an Access Service Connectivity Platform in multiple languages. This is primarily done in order to allow global access to platforms. An example of such cell structure contains:

A series of search codes (or at least one search code) is assigned to types of services. For example one code or series of codes for banks, another for weather services and a third one for airport information. This enables faster searches within the databases. Also this allows the undertaking of remote searching in multiple languages.

Each service may be described in the local language and/or in English.

Each cell contains a telephone number and a WWW link. The selection between the two will have a priority setup to define which one of the two shall be used for the connection. The user can define during the search the preference of either a telephone number or a web link.

The structure described in FIG. 7 allows a multilingual search. The multilingual search uses English as the reference language for global (international) searches.

The use of real time text or voice translators is another option for allowing global searches. When the information about a service provider is entered in a local language (such as Chinese in China) it will also be entered in English for international searches.

Information may be organized in the database in a fashion that allows listing of groups of services for the user for selection. For example a list of banks in a specific city as it is stored in the physical location code. The physical coordinates will allow a search for services according to their physical location or proximity to the user (relevant for cellular services, where the location of the user can be established accurately).

The Global database 53, described above is structured as follows:

The global database is a small database that contains the locations of other Access Service Connectivity Platforms. Other platforms may be accessed via the Internet or any other packet based mediums such as frame relay or ATM.

According to the preferred embodiment of the present invention, the following method is an example of a user session. FIG. 8 illustrates in detail how a user accesses a virtual PBX, which resides on an Access Service Connectivity Platform. The system provides connectivity within 2 or 3 layers/iterations of conversation. The following example shows connectivity with a virtual PBX.

In layer 1:

i. Users picks up the phone and receives a greeting 80.

ii. A selection is then made from the main menu of a pre-configured company/business selection 81.

iii. Confirmation 82 is performed on the selection

In layer 2:

iv. Selection 84 is performed, following the prompt 83 from the company/business database. This selection may include a subscriber to a virtual PBX or provide selection of the business/company phone line or server. In this example, the companies database is searched for the selected company.

v. Confirmation 85 is performed for the selection

vi. Connection 86 to company/business virtual PBX is executed. If the company/business does not have a registered virtual PBX on the system, the caller is connected to the company/business telephone line or server.

### Advantages of the Invention

The present invention provides for a voice activated network access system and method, wherein:

A more natural usage of the telephony infrastructure is enabled.

The need to know telephone numbers is eliminated

The replacement of the dial tone with a more natural interface.

The need for key press operations is eliminated.

Enabling central connectivity solution with respect to existing voice activated enabling that resides at the user device (for example the phone) or at the end service device (for example call center or a voice portal).

Benefits the ILEC, CLEC, Wireless service provider or the CATV service provider with added usage of networks that increases profitability.

### Alternate Embodiments

Several other embodiments are contemplated by the inventors. For example, further embodiments of the present invention are possible implementations of the Access Service Connectivity Platform with DLCs (Digital Loop Carriers), DSLAMs (DSL Access Multiplexors) or integrated access devices (IADs) using V5-type, GR-303, and TR 008 interfaces. Most wireline and some wireless network interfaces use a series of worldwide-accepted protocols between the access and the local exchange switches. The ETSI (European Telecommunications Standards Institute, Sophia Antipolis technical park, Nice, France, www.etsi.fr) standards used are V5.2 or V5.1, which are part of a series of protocols called the V5 set of protocols. Another leading standard is the GR-303 Bellcore (Telecordia) Standard. These standards emulate a direct connection between the user and the local exchange switch.

The present invention also provides for the insertion of an additional device between the Access Network (“AN”) and the Local Exchange (“LE”). This enables the ability to control every telephone call transferred from the local access to the Local Exchange switch. This additional device, located between the Access Network and the Local Exchange, is the Access Service Connectivity Platform of the present invention, with V5-type, GR-303 or TR008 interfaces. In addition, the Access Service Connectivity Platform has a VoIP interface for IP telephony 90.1 connection and Internet access. In this way, the present invention enables integration of the Access Network (AN) into switched circuit (LE) and/or VoIP network.

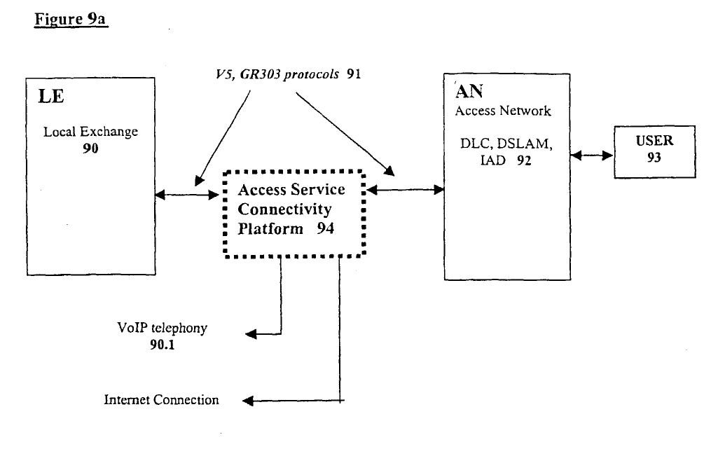

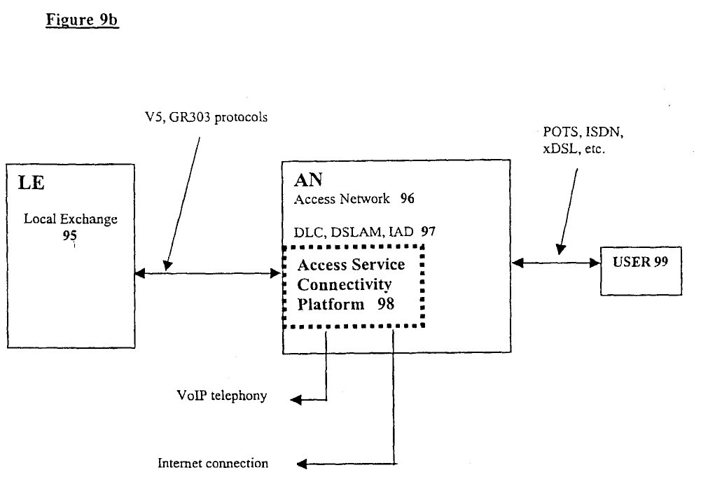

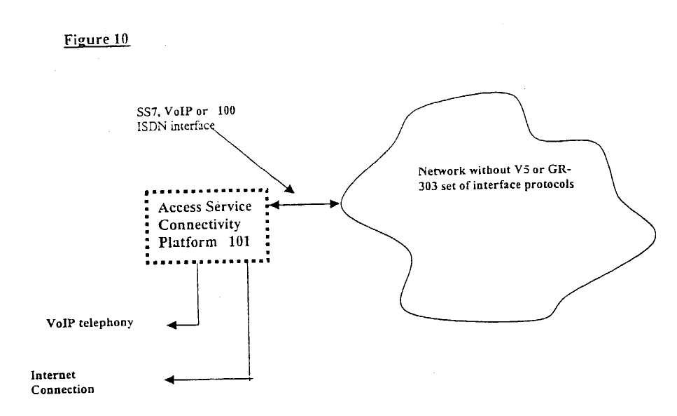

As can be seen in FIG. 9a, the Access Service Connectivity Platform 94 can block the path of every telephone call between the AN 92 and the LE 90. When Access Service Connectivity Platform 94 is in the blocking mode, it is able to distinguish between Dual-Tone Multi Frequency (DTMF), data or voice commands. A DTMF or Data connection is consequently transferred directly to its destination without blocking the connection channel. When a voice connection is recognized, the channel may be blocked, and the voice-activated interface will initiate and conduct a dialogue with the user.

In a similar embodiment to the one described in FIG. 9a the Access Service Connectivity Platform can be integrated into an Access Network device such as the Digital Loop Carrier (DLC) 97, as can be seen in FIG. 9b. When the implementation is part of the AN 96 device it will reduce the number of V5-type interfaces from 2 to 1. Although this option can be a lower cost solution, it requires replacement of the AN 96 equipment. When Access Service Connectivity Platform 98 features are added to the AN 96, such as a DSLAM or DLC (also known as LAD, Integrated Access Device) 97, it can add an additional enabling feature of controlling the DSL link with a voice activated POTS link.

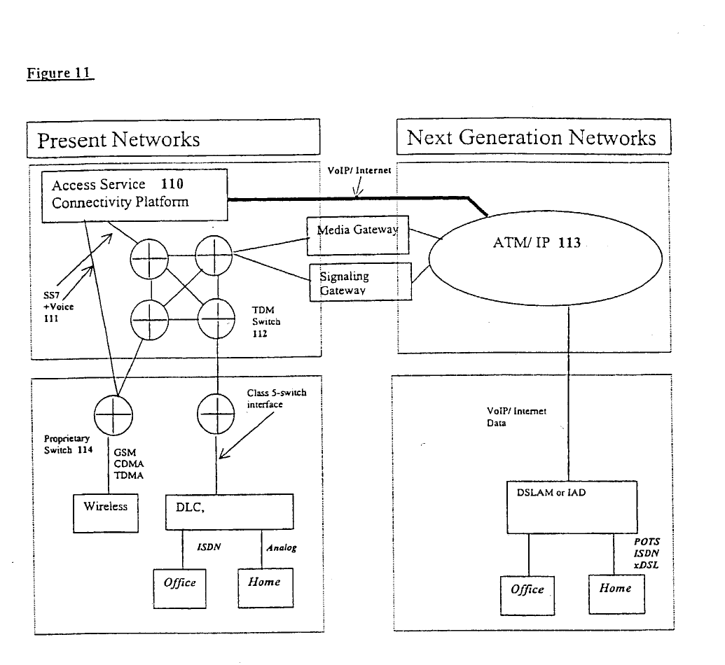

Further embodiments of the present invention include implementing the present invention externally to networks. This implementation of the platform of the present invention uses connections such as ISDN, VoIP and SS7. For example, some networks, such as cellular networks, do not have the V5 or GR-303 interface channels but they incorporate SS7 Interfaces. This can be seen in FIG. 10, where a standard interface 100 using ISDN (BRI, PRI) may be used to allow the Access Service Connectivity Platform 101 to be accessible by users of these networks.

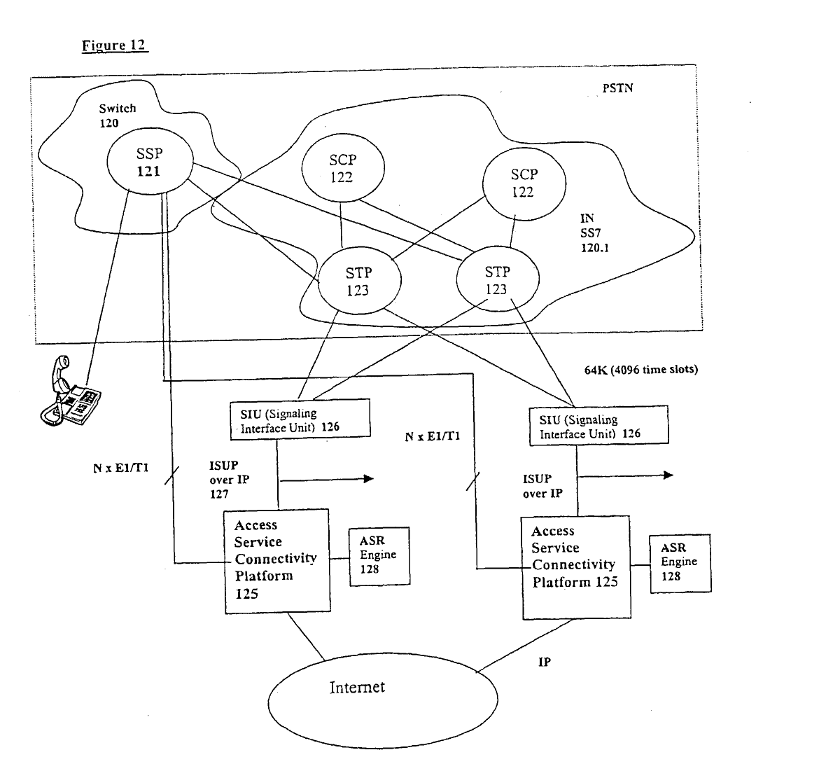

In a further embodiment of the present invention, the Access Service Connectivity Platform is integrated into commonly distributed circuit switched networks with Intelligent Network (IN) management. FIG. 11 illustrates the integration of the Access Service Connectivity Platform 110 into a next generation network, such as a packet network, also known as VoIP network. The Access Service Connectivity Platform 110 can operate in switched or Packet networks both independently or simultaneously. As can be seen in the figure, the Access Service Connectivity Platform 110 is placed within the present communications network, where it is connected to either a TDM Switch 112 or a proprietary switch 114 such as GSM, CDMA or TDMA, via SS7+Voice Interface 111. The Access Service Connectivity Platform 110 is also directly connected to the ATM/IP Network 113, such that connection to present and future networks can be achieved simultaneously This also enables migration of present networks to future networks while maintaining features and flexibility. The figure demonstrates the beneficial location of the service access connectivity platform 110 in the heart of the network.

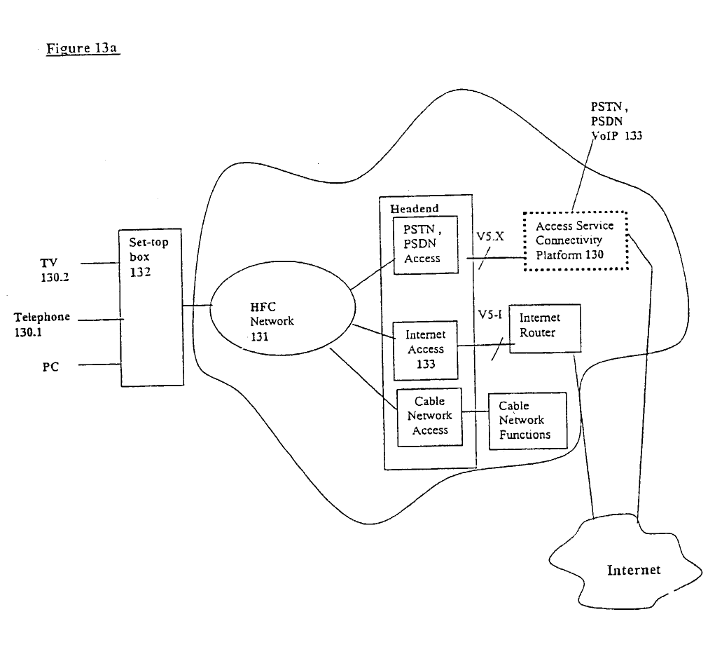

FIG. 12 shows a detailed view of the Access Service Connectivity Platform 125 integration into the Intelligent Network infrastructure. Access Service Connectivity Platform 125 is intentionally applied as a redundant construction, in order to ensure high reliability and close to zero down time. The voice circuits are supplied via the SSP 121, which is managed by the IN (Intelligent Network) 120.1. Connection to the IN network is done via a minimum of 2 STP circuits 123 for redundancy purposes. The system can be expanded with the addition of any of the components such as additional SIUs 126, additional Access Service Connectivity Platforms 125 and additional voice circuits 129. The system can also be expanded by increasing the bandwidth of IP circuits and ASR engines 128. The figure demonstrates the seamless connection of the telephone user with the voice switching network and the packet driven network.

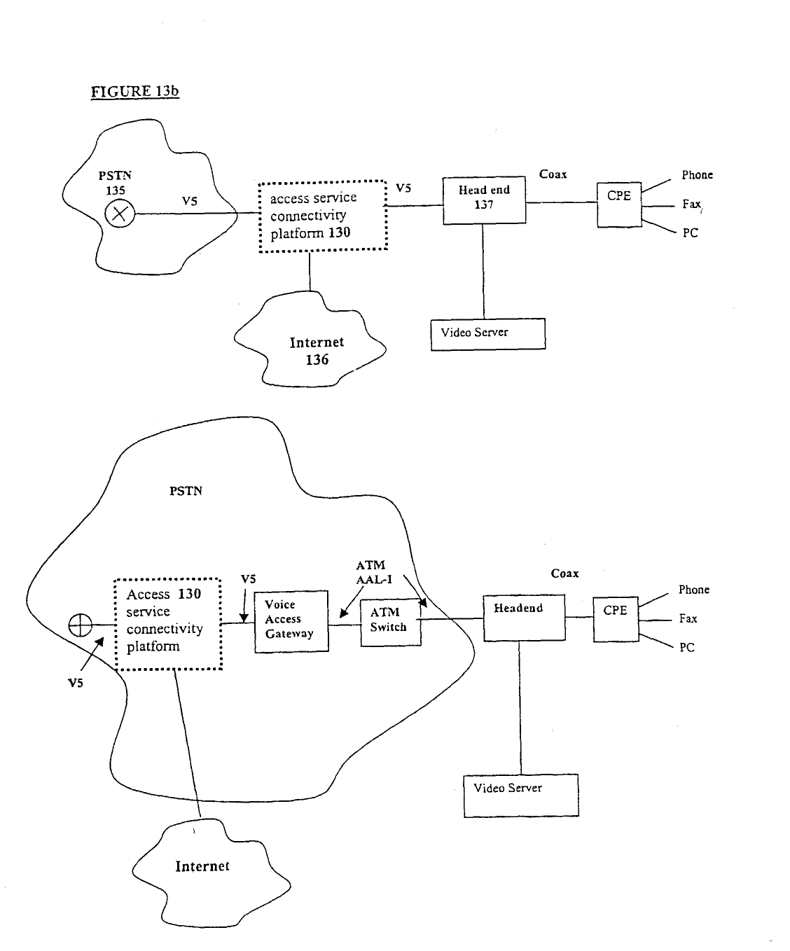

FIGS. 13a,b illustrate the Access Service Connectivity Platform 130 integration into an HFC (Hybrid Fiber Coax) 131 network. Access Service Connectivity Platform 130 adds voice-activated connectivity to the telephones, which are connected to the set-top boxes 132 at the subscriber interface. The interface is used in a blocking fashion that interfaces between the voice circuits of the HFC network 131 and the PSTN or PSDN switched networks 133. The system also allows an alternate connection to the Internet with alternate billing options and alternate enabling applications. For example, the connection allows placing orders, such as ordering a movie, on the Internet by simply voice dialing 130.1 to the movie on demand provider and by controlling voice/visual menu selections from the movie on demand provider servers on the television screen 130.2. According to this embodiment, the Access Service Connectivity Platform 130 is connected to the Set-top box (Cable TV device) 132 via the HFC and the Internet 133. Voice commands or voice prompting screen selections via a cable TV output device, can enable online navigation or services, such as ordering movies from an Internet located service. The present embodiment may make use of the following protocols: V5.1, V5.2, V5X.X TR008 protocol and GR303 protocol.

Emerging CATV networks will require telephony links which are based on existing V5/GR303/TS008 interfaces. These interfaces may easily be integrated within the scope of the present invention. FIG. 13a provides a more elaborate illustration of how the present embodiment may operate with the use of V5 type of interfaces. In this application, the Access Service Connectivity Platform 130 is used in a blocking fashion. Similar applications may be executed using GR303 type and the TS008 type interfaces.

FIG. 13b illustrates two additional, more elaborate, applications of the present invention in an HFC (Hybrid Fiber Coax) a CATV network. According to the first part of the figure, it can be seen how the Access Service Connectivity Platform 130 may be located in the network cloud, between the PSTN 135, the Internet 136 and the head end 137. The second part of the figure demonstrates how the Access Service Connectivity Platform 130 may be located between the V5 interface in the PSTN and an ATM, packet driven network such as the CATV network

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for enabling voice activated network access, comprising:
i. at least one voice enabled communications device;
ii. a service provider for connecting said communications device to a network;
iii. said network for connecting said at least one communications device with a network-based element;
iv. an Access Service Connectivity Platform for connecting and routing voice based requests from said at least one communications device; and
v. a database for storing data relating to said connecting and said routing functions; and

2. The system of claim 1, wherein said at least one user communications device is a device operative on networks selected from the group consisting of ILEC, CLEC, CATV and Wireless.

3. The system of claim 1, wherein said Access Service Connectivity Platform comprises:
a. a physical layer interface for interfacing between the Access Service Connectivity Platform and at least one network infrastructure;
b. a service routine engine for conducting a dialogue with at least one user accessing said Access Service Connectivity Platform;
c. a local database for storing local area data for said at least one network infrastructure;
d. a network management interface for establishing a connection between said at least one user and a destination in said at least one network infrastructure; and
e. a hosting platform for hosting services that can be accessed via the Access Service Connectivity Platform.

4. The system of claim 3, wherein said Access Service Connectivity Platform further comprises a global database for storing destinations of other access server connectivity platforms, to enable global connectivity.

5. The system of claim 3, wherein said Access Service Connectivity Platform further comprises a central server for serving information to said Access Service Connectivity Platform

6. The system of claim 3, wherein said local database is further comprised of:
I. a series of search codes assigned to types of services, for enabling enhanced user searches on said database; and
II. a service routine for enabling responses to user requests; a service provider to create said database in a scalable and customizable way.

7. The system of claim 6, wherein said search codes enable execution of remote searching in multiple languages.

8. The system of claim 6, wherein priorities of said database are managed by user directly.

9. A system for enabling global voice activated network access across multiple networks, comprising:
i. at least one communications device;
ii. at least two networks, such that a first network is a local network for said at least one communications device, and such that an additional network contains data requested by said at least one communications device;
iii. said networks for connecting said at least one communications device with a networkbased element;
iv. at least one Access Service Connectivity Platform, for connecting and routing data requests from said at least one communications device;
v. at least one local database for each of said at least two networks, for storing local user connectivity data; and
vi. a global database for storing destinations of at least two said access server connectivity platforms, such that access to global searches is enabled.

10. A method for voice-enabled network access, comprising the steps of:
i. providing an Access Service Connectivity Platform in a network;
ii. identifying when a user is connecting to said network, using said Access Service Connectivity Platform;
iii. initiating a dialog with said user, to request a command, by said Access Service Connectivity Platform;
iv. waiting for a command that identifies a destination for a request from said user, by said network Access Service Connectivity Platform;
v. after receiving a response from the user, searching a local database for connection data for said request destination, by the Access Service Connectivity Platform; and
vi. connecting calling party to said destination;

11. The method of claim 10, wherein said Access Service Connectivity Platform is located between a Local Exchange (LE) and an Access Network (AN), such that said Access Service Connectivity Platform blocks and processes every voice command transferred from said LE to said AN.

12. The method of claim 10, wherein said Access Service Connectivity Platform is located within an AN device or platform, such that said Access Service Connectivity Platform blocks and processes every voice command transferred from said LE to said AN.

13. The method of claim 10, wherein said Access Service Connectivity Platform is located within an HFC network, such that all voice commands initiated though a set-top box are blocked and processed by said Access Service Connectivity Platform.

14. The method of claim 10, wherein said Access Service Connectivity Platform is located between a circuit switched network or a VoIP network, the Internet and a HFC network, such that all voice commands initiated though a user set-top box are blocked and processed by said Access Service Connectivity Platform.

15. The method of claim 14, wherein said HFC network is a CATV network.

16. The method of claim 10, wherein said Access Service Connectivity Platform is located within a PSTN network, such that all voice commands initiated though a set-top box are blocked and processed by said Access Service Connectivity Platform.

17. The method of claim 10, wherein said Access Service Connectivity Platform is located within a circuit switched network, and is connected via a VoIP interface to a packet data network, such that voice commands are processed from circuit switched and packet networks.

18. The method of claim 10, wherein said Access Service Connectivity Platform is located within an Intelligent Network (IN), such that all voice commands initiated though a packet network are processed by said Access Service Connectivity Platform.

19. The method of claim 10, wherein said Access Service Connectivity Platform is located within a switched network center, and is connected to an ATM packet network. Such that all voice commands initiating from said switched network or ATM network and said packet network are processed by said Access Service Connectivity Platform.

20. The method of claim 10, wherein said Access Service Connectivity Platform is located externally to a network, using an ISDN interface, such that all voice commands initiated though said network are processed by said Access Service Connectivity Platform

21. The method of claim 10, wherein said Access Service Connectivity Platform is located externally to a network, using an VoIP interface, such that all voice commands initiated though an Internet connection are processed by said Access Service Connectivity Platform.

22. The method of claim 10, wherein said Access Service Connectivity Platform is located externally to a network, using a SS7 interface, such that all voice commands initiated though said network are processed by said Access Service Connectivity Platform.

23. The method of claim 10, further comprising:
vii. checking monitoring information packets or connection time for charging purposes, by a management layer; and
viii. when connection is terminated by one of said users, notifying said management layer that said connection is terminated.

24. The method of claim 10, where following step v.:
a. handling said call by said network,
b. disengaging said service access connectivity platform from connection to said user, such that there is a “throwing” of the voice channel back into said network, in a way that eliminates usage of service access connectivity platform resources.

25. The method of claim 10, wherein said dialog is conducted using information selected from the group consisting of voice, text or data packets.

26. The method of claim 10, where location of Access Service Connectivity Platform enables maintaining the existing user (source caller) device without the need for update to a voice activated system.

27. The method of claim 10, where location of Access Service Connectivity Platform enables maintaining existing service provider (call destination) platforms and infrastructure, without the need for update to a voice activated system.

28. The method of claim 10, wherein said connection to said destination provides Eye free and hands free telephony use, such that voice-based connectivity and browsing can be executed.

29. The system of claim 10, wherein said Access Service Connectivity Platform enables telephonic access to users and services to Access Service Connectivity Platform databases, such that a service provider defines connection preferences.

30. The method of claim 10, wherein said Access Service Connectivity Platform enables multilingual search and access to globally located services, users and to other network resources

31. A method for accessing network services, users and resources on at least two networks, comprising the steps of
i. providing an Access Service Connectivity Platform in a network;
ii. identifying when a user is connecting to said network, using said Access Service Connectivity Platform;
iii. initiating a dialog with said user, to request a command, by said Access Service Connectivity Platform;
iv. waiting for a command that identifies a destination for a request from said user, by said network Access Service Connectivity Platform;
v. after receiving a response from the user, for destinations that are external to a local network, accessing a global access connectivity database in order to locate an exact final destination; and
vi. after a destination has been identified, connecting calling party to said destination.

32. The method of claim 31, further comprising:
vii. checking monitoring information packets or connection time for charging purposes, by a management layer; and
viii. when connection is terminated by one of said users, notifying said management layer that said connection is terminated.

33. A platform for enabling voice activated network access comprising:
i. an LE (Local Exchange) for performing circuit switched connections
ii. an AN (Access Network) for connection to network users and services;
iii. at least one communications interface for connection to AN(Access Network).
iv. an access connectivity platform, located between said access network and said local exchange, such that said platform blocks all communications passing between LE and AN.

34. The platform of claim 33, wherein said access network is integrated within a device selected from the group consisting of a Digital Loop Carrier (DLC) Integrated access Device, a DSL access multiplexer (DSLAM) and an Integrated Access Device (IAD).

35. The platform of claim 33, wherein said communications interface is selected from the group consisting of V5.X-type, GR303 or TR008 interface, such that the interface is used in a blocking fashion, where the voice channel does not reach the local exchange until it has been processed by the Access Service Connectivity Platform.

36. The platform of claim 33, wherein said voice activated network access has a IP interface, for enabling VoIP telephony connection and Internet access.

37. The platform of claim 33, wherein said voice activated network access is located within said access network.

38. A platform for enabling voice activated network access in a HFC (Hybrid Fiber Coax) network, comprising:
i. at least one set-top box for enabling user access to the Hybrid Fiber Coax network, connected to the group consisting of PC, telephone and TV.
ii. at least one voice-enabled input device connected to said set-top box, for initiating voice commands through to a HFC network;
iii. a HFC network for connection of set-top box to head-end.
iv. a head-end for connection of HFC network to external resources; and
v. at least one Access Service Connectivity Platform, such that said Access Service Connectivity Platform is used in a blocking fashion between voice circuits of the HFC and external networks.

39 The platform of claim 38, wherein said Access Service Connectivity Platform is located external to a PSTN network, such that said Access Service Connectivity Platform processes all voice commands transferred from said head end to said PSTN network.

40. The platform of claim 38, wherein said Access Service Connectivity Platform is located, such that said Access Service Connectivity Platform processes voice commands from user to the Internet and CATV resident applications and services.

41. A platform for enabling voice activated network access with an external attachment to network, comprising
i. a network switching or packet infrastructure.
ii. an interface for connection said network to Access Service Connectivity Platform from group consisting of ISDN, SS7 and VoIP.
iii. an Access Service Connectivity Platform for enabling voice activated connectivity functions
iv. an IP interface for integration with Internet and VoIP networks.

42. A platform for enabling voice activated network access in a distributed circuit switched network, comprising:
i. a circuit switched network for switching voice circuits
ii. a SS7+Voice interface for connection of Access Service Connectivity Platform to said network.
iii. a packet based network for connecting said Access Service Connectivity Platform.

43. The platform of claim 42, wherein said distributed circuit switched network is connected to a VoIP network, such that voice circuits in both networks are serviced by Access Service Connectivity Platform for enabling voice activated connectivity to each network independently and to both simultaneously.

44. A platform for enabling voice activated network access in a Intelligent Network (IN), such that the IN has a redundant infrastructure, comprising:
i. an Intelligent Network for managing networks selected from the group consisting of circuit switched and VoIP networks;
ii. at least two SIU for redundancy purposes;
iv. at least two Access Service Connectivity Platforms for performing network voice activated functionality.
v. at least two IP circuits for connection to Internet-based circuits.
vii. at least two ASR engines for enabling voice recognition functions.

45. The platform of claim 44, wherein said Access Service Connectivity Platform enables an alternate connection to the Internet with alternate billing options and alternate applications enabling.

46. A method for enabling voice-enabled network access, comprising the steps of
i. connecting a user to an Access Service Connectivity Platform;
ii. presenting said user with a selection of data requests, service or user destinations
iii. receiving elected said requests;
iv. identifying destination of said requests, by the access service connectivity platform; and
v. offering a preferred destination to said user from a switched circuit, VoIP telephony connection or Internet located site.

47. The method of claim 46, wherein said preferred destination is from a VoIP telephony connection.

48. The method of claim 46, wherein said preferred destination is from a network-based site.

49. The system of claim 46, wherein said global Access Service Connectivity Platform is operated using technologies selected from the group consisting of IVR, ASR, TTS and DTMF.

50. A method for enabling hands-free and eyes free access to services, telephone numbers and IP addresses, such that a user accesses these services via vocal dictation, comprising the steps of
i. providing an Access Service Connectivity Platform, for connecting and routing user communications;
ii. initiating said communications session with any voice-enabled communications device, by said user;
iii. routing said communications session to said Access Service Connectivity Platform;
iv. dictating a search request, by said user, to Access Service Connectivity Platform via said communications device;
v. searching a database for local and global data related to requested destination;
vi. executing database searching by a local routine in a local language of a local database.
vii. after finding said destination, connecting said user to destination of said request.

51. The method of claim 50, wherein said selecting services includes voice browsing.

52. The method of claim 50, wherein said hands free and eyes free enable access to services stored on an Access Service Connectivity Platform, locally hosted services such as services selected from the group consisting of Virtual PBXs, yellow pages and white pages information.

53. The method of claim 50, wherein there is a central location where different platforms can pull information from a central server comprising of local and global databases, such that said server serves information from multiple platforms to users and said hosted services such as virtual PBXs, Yellow pages and said White pages data.

54. The method of claim 50, wherein existing networks are migrated into a complete IP environment, such that global IP world connectivity capability is provided on existing switched networks, with current equipment and with packet equipment.

55. The method of claim 50, wherein said hands-free access to services includes a multilingual search facility.

56. The method of claim 50, wherein real time voice translators are employed to facilitate global searches, such that information about a service provider is entered in a local language, and is automatically converted into English for international searches.

57. The method of claim 50, wherein every entry in the services database has an address and exact physical location, such that said physical location information allows the listing of all services within a specific area of a user.

58. The method of claim 50, wherein said connection and routing functions are located in a platform which is part of an Intelligent Management infrastructure of a network.

59. A method for enabling searches, comprising the step of creating a database “cell”, wherein use of code in the “cell” identifies groups of information for search of the databases, according to the following steps:
i. requesting a service category in a specific location, by a user;
ii. accessing an Access Service Connectivity Platforrn, which identifies a search code for said requested category;
iii. pulling out requested information from a data base in a fast operation which searches only for said search code of said category of service, within said services database.
iv. using said information for connection of user to a destination

60. The method of claim 59, wherein said Active Service Connectivity Platform hosts a multitude of hosted applications, such that no additional hardware requirements by hosted applications

61. The method of claim 59 where fast searches are enabled due to “grouping” of cells.

62. The method of claim 59, further comprising:
v. hosting PBX functions on said service connectivity platform;
vi. replacing said PBX functions which reside on legacy enterprise networks.

63. The method of claim 62 where virtual PBX emulates typical PBX functions and employs voice activated functions

64. A system for replacing dial tone for the PSTN phone lines, such that a user automatically accesses an automated message from the system providing an interface for voice based communication and navigation of at least one network comprising the steps of
i. a handset placed in the off hook position
ii. Access Service Connectivity Platform greeting is played instead of dial tone. Greeting may be in the form of “Good morning, where can I connect you?”
iii. a dial tone may presented following the greeting message for compatibility with historical dial tone functions.
iv. user can barge-in at any time for giving voice commands for connection purposes
v. voice commands can be given at any time during greeting or the following dial tone or any tone or background music, as preferred.

65. The system of claim 64, wherein said Access Service Connectivity Platform enables access to users or services via telephone numbers, using DTMF without the voice enabled functions of the Access Service Connectivity Platform.
